(19) United States
(12) Patent Application Publication
(10) Pub. No.: US 2006/0053437 A1
(43) Pub. Date: Mar. 9, 2006

(54) Secure method for providing, verifying, and clearing negotiable discount coupons utilizing a distributed processing network

(76) Inventor: David Wayne Bruner, Provo, UT (US)

Correspondence Address: Kory D. Christensen;STOEL RIVES LLP, One Utah Center, 201 South Main Street, Suite 1100, Salt Lake City, UT, 84111, US

(21) Appl. No.: 11/253,133

(22) Filed: Oct. 18, 2005

Related U.S. Application Data
(63) Continuation-in-part of application No. 10/171,505, filed on Jun. 12, 2002.
(63) Continuation-in-part of application No. 09/982,632, filed on Oct. 18, 2001.
(63) Continuation-in-part of application No. 11/242,993, filed on Oct. 4, 2005.

(51) Int. Cl. G07G 1/14; H04N 7/16; G07G 1/00

(52) U.S. Cl. 725/23; 705/14

(57) ABSTRACT

A method for increasing security in the issuance of discount coupons to consumers includes providing a traceable, printable medium to remote users for the printing of discount offer data thereon in order to create negotiable discount coupons, each traceable, printable medium comprising at least one coupon shell including a prerecorded security code traceable to the remote user to whom it was provided. Identification data is maintained within at least one database related to each remote user to whom the traceable, printable medium was provided, the at least one database providing an electronic link between at least one aspect of the identification data and the prerecorded security code. An electronic connection is established to at least one issuing station that includes at least one searchable database of discount offers accessible via a distributed processing network. Electronic verifications are provided to each issuing station that a specific remote user has met one or more requirements imposed by the program manager to print discounts onto an issue of traceable, printable medium provided by the program manager. Data is recorded for each discount offer chosen for print by a remote user. Each recorded data is linked to the security code found on the package of traceable, printable medium issued to the remote user choosing to print a particular discount offer.

### RELATED APPLICATIONS

This application is a continuation-in-part of U.S. patent application Ser. No. 10/171,505, filed Jun. 12, 2002, for “SECURE METHOD FOR PROVIDING NEGOTIABLE DISCOUNT COUPONS TO CONSUMERS USING A DISTRIBUTED PROCESSING NETWORK.” This application is also a continuation-in-part of U.S. patent application Ser. No. 09/982,632, filed Oct. 17, 2001, for “METHOD FOR ALLOCATING NEGOTIABLE DISCOUNT COUPONS TO CONSUMERS USING A DISTRIBUTED PROCESSING NETWORK.” This application is also a continuation-in-part of U.S. patent application Ser. No. 11/242,993, filed Oct. 4, 2005, for “METHOD AND SYSTEM FOR SECURE PRINT-AT-HOME DISCOUNTS.” Each of the foregoing applications are incorporated herein by reference.

### BRIEF DESCRIPTION OF THE DRAWINGS

FIG. 1 is a block diagram of a distributed processing network;

FIG. 2 is a sample of traceable, printable medium, such as paper, having three, contiguous, preprinted, coupon shells, each of which includes tear perforations;

FIG. 3 is an illustration of a reverse side of a coupon shell and a sample of information that may be collected from a Remote User upon issuance of the traceable printable medium;

FIG. 4 is a block diagram illustrating the data flow associated with the distribution of a traceable, printable medium and the registration and setup processes involving an Issuing Station, a Remote User and the Program Manager;

FIG. 5 is a block diagram illustrating the process of a Remote User creating a negotiable discount coupon;

FIG. 6 is a mock-up sample of a negotiable coupon in which the offer data, graphics data, and unique identification code (shown as a barcode and as a series of numeric characters) have been printed onto a coupon shell by a Remote User to whom the traceable paper, or other traceable, printable medium was assigned;

FIG. 7 is a block diagram illustrating the verification process and the clearing process involved in the printing and redemption of a negotiable discount coupon;

FIG. 8 is a block diagram illustrating the operational function of an interactive grocery list system;

FIG. 9 is a sample remote user input field for an interactive grocery list system; and

FIG. 10 is a mock-up result of the choices made by a remote user utilizing an interactive grocery list system.

### DETAILED DESCRIPTION

As an overview, a method is provided for supplying, tracking, and clearing negotiable discount coupons issued to Remote Users using a distributed processing network incorporating electronic security features, including print controls and unique identification codes, and providing traceable paper or other traceable printable medium to positively identified individuals for the purpose of printing discounts thereon; which discounts may be securely monitored and accurately cleared by a third party entity on behalf of Internet discount providers, retailers, or other similarly-situated entities who have received the coupons for redemption.

The method may include the receipt of verifiable, unique personal data from individuals wishing to use the traceable, printable medium for the printing of discounts electronically at remote terminals, and electronically linking the identity of the individuals with the security codes assigned to them.

In one embodiment, the method is implemented by providing a central monitoring system utilizing at least one server system accessible via the network and operated by a Program Manager company (Program Manager). The method may also include one or more Issuing Station(s) offering a searchable database(s) of discount offers, authorized by participating businesses, referred to herein as Originator Stations, and one or more Remote Users having access to the searchable database(s) for the home printing of discount offers related to the purchase of various products and services. Each of the available offers may be graphically displayed on the Remote User's client system as provided by the Issuing Stations. For purposes of reference, the Remote User's client system may be a personal computer system or other Internet appliance. So that Remote Users will not be able to print offers as graphically displayed on their screens, offers may be printed in different formats from those graphically displayed on the Remote Users' client system.

The method also provides that a discount offer be printed on traceable paper or other traceable, printable medium containing coupon shells, to create a negotiable discount coupon.

The negotiable discount coupon may then be redeemed by a Remote User at a participating merchant or retailer location, defined herein as a Redemption Station, to receive the authorized discount.

As part of the method, an electronic communication will be established at different times or simultaneously between one or more Issuing Station(s) and one or more Remote User(s) and with the Program Manager server system, to allow for the printing of discount offers presented by the Issuing Station(s) to a Remote User at a Remote User station within a framework established by the Program Manager. In one embodiment, a printer is accessible to the Remote User for the authorized printing of the discount offer onto traceable paper or other traceable, printable medium, to create a negotiable discount coupon.

The method may also require the establishment of a system for distributing traceable sheets of paper or other traceable, printable medium, to each of the Remote Users. The traceable, printable medium may be distributed, for example, by various merchants, banks, or retailers who will verify the identity of the receiving Remote User, via a valid driver's license or other acceptable equivalent form of identification, and enter information into a system database that will associate the delivered traceable, printable medium with the receiving Remote User, or identification of the Remote User may be made online by the Program Manager, such that the traceable, printable medium may be mailed to the Remote User. According to one embodiment, each sheet of traceable, printable medium will include a security code individually identifying each issue of traceable, printable medium. Thus, at the time of coupon redemption, the traceable, printable medium may be linked to the receiving Remote User in order to reduce the likelihood of fraud and prevent the unauthorized use of discount offers.

In order to receive authorization to print discount offers and/or promotions originating from an Issuing Station database, the Remote User may be required to register with the Issuing Stations. The Issuing Stations' server systems may then confirm with a Program Manager that the information previously recorded at the time of distribution of the package of traceable, printable medium corresponds to the Remote User's registration information, and that the Remote User has been properly registered with the Program Manager.

Upon authorization by the Program Manager's server system, the Remote User may then be allowed to print discount offers presented by the Issuing Stations, contingent on the fulfillment of any additional requirements that may be stipulated by the Program Manager and by a particular Issuing Station. In one configuration, the system creates a verification that the Remote User registering with a specific Issuing Station has received an issue of traceable, printable medium, that the Remote User's personal information is on record and linked with the particular issue of traceable, printable medium, and that the Remote User has electronically registered with a Program Manager and is authorized to print discounts offered by participating Issuing Stations.

The system also authenticates the flow of information between Issuing Stations, Remote User Stations, Originator Stations, and Redemption Stations, making the information more useful for marketing purposes. The accuracy of identifying information associated with a Remote User registering with a particular Issuing Station is assured, as the Remote User registration is verified with the information received from the Remote User at the time of the issue of the traceable, printable medium, and again at the time of the electronic registration by the Remote User with the Program Manager.

According to one embodiment, one or more sheets of traceable, printable medium are delivered to each of the participating Remote Users by the Program Manager through distribution channels heretofore disclosed above, so that discount offer data may be printed thereon by the Remote User, thereby creating negotiable discount coupons. The traceable, printable medium itself may incorporate watermarks, colored fibers, polymer security thread, or pre-printed coupon formatting, also referred to as coupon shells, which may be printed with concentric fine lines, micro-printing, color-shifting ink, and/or other identifiable, but not easily duplicated features.

Additionally, multiple coupon shells may be pre-printed on each sheet of traceable, printable medium. A coupon shell is further defined as an area contained within the boundaries of the traceable, printable medium, which contains identifying marks and features for the purpose of creating a secure negotiable coupon. In addition to the features inherent in the traceable, printable medium, each coupon shell may include other prerecorded (i.e., preprinted or pre-encoded) identifying features, such as barcodes, holographic stamps, similar to those placed on boxes of distributed software, two-dimensional codes, heat-sensing ink, a unique membership number and/or serial numbers, a scanable microchip, or a radio frequency identification (RFID) tag. Each of the sheets may be perforated in order to facilitate the separation of multiple coupons contained on a single sheet. Laser-cut perforations, using a special pattern, may be employed as an additional security feature.

In one implementation, each coupon shell will contain at least one pre-printed or embedded security code, which will uniquely identify each coupon shell. The security code may be a barcode, serial number, radio frequency identification, or other identification device. A pre-printed security code may be printed on the back of the coupon shell to protect the code from being distorted by data printed from the Remote User's printer onto the front of the coupon shell.

The method may also require that Remote Users register the security code and/or a verification code found on, or within a specific issued package of traceable, printable medium, with the Program Manager's server system. The Program Manager's server system will then verify that the information previously recorded at the time of distribution of the package of traceable, printable medium correlates with the Remote User's registration information.

Upon authorization by the Program Manager's server system and after meeting any additional requirements specified by the Issuing Station(s), the Remote User may then be allowed to print discount offers presented by the Issuing Station(s). This matching of registration information by a Program Manager with the information gathered at the time of issue of the traceable, printable medium creates an additional level of security by insuring that the issued package of traceable, printable medium is registered by the Remote User to whom the package was assigned.

In one method of printing discount offer data onto coupon shells, an executable program, provided by the Program Manager company and downloadable from the Program Manager server system, is loaded on the Remote User's client system. The executable program may be defined as a custom application provided by the Program Manager for the purpose of creating print controls and facilitating data flow to ultimately allow, under the terms set by the Program Manager, Remote Users to print discount offer data and security data on a printer connected or networked to the Remote User's client system, taking into consideration the operating system residing on the Remote User's client system. The executable program controls printing of discount offer data and security data onto coupon shells in response to data received by the executable program from the Issuing Station providing the discount offer and from the Program Manager's server system. As an alternative, the executable program may be provided to Remote Users in a physical medium—such as a CD.

In order to accurately position the printing of discount offer data and security data within the coupon shells, the executable program residing on the Remote User's client system queries the operating system to determine the available print area of the printer attached to or networked to the Remote User's client system. The operating system returns a result set, which includes maximum x and y print coordinates, to the executable program that allows the executable program to calculate appropriate placing of text, graphics, and security data within the coupon shells. This calibration information may be provided to the executable program located on the Remote User's client system, or alternatively, to the Program Manager's server system. Using this information, the printing of discount offer data and security data on the coupon shells can be adjusted to correspond to the position and size of printable fields on the coupon shell.

The data provided from the Issuing Station's server system database and from the Program Manager's server system, which may include, but is not limited to, text data, graphics data, and security data, may be requested as a Remote User chooses to print out a discount offer provided by the Issuing Station's server system database and graphically displayed on the Remote User's client system.

An executable program, or an alternative program providing the same functions as the executable program, may also be installed on the Issuing Station's computer server system. In one scenario, the executable program or other similar program residing on the Issuing Station's computer server system receives the request initiated by the Remote User for the discount offer and related data and then interacts with the Program Manager's server system to verify the authorization of the Remote User to participate in the printing of discount offers, assuming verification has not already been received, and, to receive a unique identification code to be assigned to the Remote User requested discount offer for the purpose of printing onto the traceable, printable medium, by a printer connected or networked to the Remote User's client system.

As one option, the Program Manager's server system will assign a unique identification code to each set of discount offer data once a discount offer, provided by an Issuing Station is chosen for printing by a Remote User utilizing a client system. The executable program or other similar program residing on the Issuing Station's computer server system may receive the unique identification code. That code, along with the other related offer data, may be sent to the executable program residing on the Remote User's client system to act together with the Remote User's printer calibration information to execute the printing of the discount offer, the unique identification code, and other related offer data and graphics data onto the coupon shells provided on the traceable, printable medium.

One method for the Program Manger's computer server system to assign the unique identification code to a specific discount offer is for the executable program or other similar program residing on the Issuing Station's computer server system to send data identifying the specific discount offer and the specific product to which the discount offer is linked to the Program Manager's server system. The discount offer and related product may have an assigned coupon code and a UPC (uniform product code), identifying both the product and the related discount or promotion to be given on the purchase of the product. For one option, the said coupon code and UPC code may be included in the unique identification code assigned by the Program Manager to the specific discount offer.

Optionally, specific information, including, but not limited to, the discount amount and the uniform product code, related to the discount offers residing on the Issuing Stations' computer server systems may be kept in a database managed by the Program Manager within the records containing the Issuing Stations' specific data. Issuing Stations may utilize XML programming or another similarly functional program, to download the specific data from the databases in a format manageable by the Program Manager to place the information within the Issuing Stations' records contained in the database managed by the Program Manager.

Discount offers residing in the Program Manager's database within the Issuing Stations' records may be assigned offer key codes that will identify the offers being requested for print from the Issuing Stations by the Remote Users. In one option, these offer key codes identify the discount offers being provided to the Remote Users by the Issuing Stations by tagging the data related to the same offers residing on the Program Manager's database. Once a discount offer has been requested by a Remote User, the Issuing Station providing the discount offer may send the offer key code and the Remote User identification information to the Program Manager's server system.

The Program Manager's server system may then identify the offer being requested by the Issuing Station's server system and the Remote User requesting the discount offer for print. The Program Manager's server system may then assign and send to the Issuing Station a unique identification code that will then, along with the related discount offer data, be sent to the executable program residing on the Remote User's client system for printing on the traceable, printable medium assigned to the Remote User. The Program Manager's server system may then record the unique identification code and the discount offer data and link the code and data with the security code assigned to the Remote User choosing to print the offer as provided on the traceable, printable medium issued to the Remote User. In one scenario, the offer key codes are generated by the Issuing Stations providing the discount offers.

As one option, the unique identification code consists of information sufficient to identify the product or service for which a discount offer has been chosen and the amount of discount being offered. Other than the included UPC and coupon codes, the unique identification code may be randomly generated.

As an additional option, the Unique Identification code is tied electronically in a database managed by the Program Manager with the security code issued to the Remote User printing the discount offer, and may also tie in with information related to the identity of the registered Remote User, such as one or more fields (user name, home address, telephone number, and others) related to information gathered about the Remote User. This creates an additional level of security by providing an assurance that the unique identification code has been printed on the coupon shells assigned to the Remote User printing the data.

Other information, which may be included in or tied to the unique identification code may be the time and date of the printing of discount offer data, the Issuing Station from which the search was performed, the number of prints chosen by a Remote User within a given print session (more than one offer being chosen for print at the same time), and data related to other products for which discount data was printed in the same print session. Additionally, family codes associated with products being offered and discounted by manufacturers, or Originator Stations, may be stored electronically and tied to the unique identification code.

As another embodiment, a barcode incorporating the UPC code and coupon code identifying the product and the related discount for an offer chosen for print by a Remote User may be printed in another position separate from the unique identification code, or as an alternative to the unique identification code, onto the front of the coupon shell. This will allow Redemption Stations who do not have systems in place to read the unique identification code to have access to read the more traditional product/discount barcode. In this scenario, the Redemption Station may either read the security code for the purpose of verifying and tying the security code to the redeemed discount, or may be required to send the physical coupon in to the Program Manager for subsequent verifications.

As another option, once a Remote User chooses to print a specific discount offer provided by an Issuing Station, the discount offer and related product data—including, but not limited to, the specific discount offer and the uniform product code of the product being discounted—requested by the Remote User from the Issuing Station's discount-offer database, may be sent to the Program Manager's server system, which in turn may link the unique identification code to the print request, record the data, link the data with the remote user's assigned security code, and then send the unique identification code, and possibly, the UPC code and coupon code, to the executable program residing on the Issuing Station's server system.

In one scenario, data electronically sent to the Remote User is sent using an encrypted format. The executable program residing on the Remote User's client system may then receive the print data provided by the Program Manager and by the Issuing Station from the Issuing Station's server system. The executable program may then decrypt the print data and use available calibration data, whether resident from the Remote User's client system or provided by the Program Manager's server system, to format the print data for printing on a printer accessible to the Remote User's client system. The executable program may then send the prepared information to the accessible printer, where it may be printed within the coupon shells pre-printed on a sheet traceable, printable medium.

As another alternative to printing discount offer data onto coupon shells, a browser-based plug-in, provided by the Program Manager and downloadable from the Program Manager's Server System, may be loaded on the Remote User's client system. The plug-in may control printing of discount offer data and security data onto coupon shells in response to data received by the plug-in from the Issuing Station providing the discount offer and from the Program Manager.

In order to accurately position the printing of discount offer data and security data within the coupon shells, the plug-in may query the Remote User's operating system to determine the available print area of the printer attached to or networked to the Remote User's client system. The operating system returns a result set, which includes maximum x and y print coordinates, to the plug-in that allows the plug-in to calculate appropriate placing of text, graphics, and security data within the coupon shells. The plug-in may then perform operations similar to that of the executable program described herein.

As an additional level of security, rules for negotiability of the coupon may be pre-printed on the coupon shell. For example, one rule may be that coupons with noticeable alternations will not be honored. The coupon rules may also include instructions to refer the Redemption Station to a secure online database for further validation of the coupon.

In one embodiment, a system is provided for verifying the authenticity of a potentially negotiable coupon which has been presented for redemption. A coupon may be considered negotiable under one or more of the following conditions:
1. It contains the offer data and security data relating to a valid discount offer on a product or service as specified by the Issuing Station and by the Program Manager.
2. In one embodiment, the designed correlation required by the Program Manager between the pre-printed security code and the Remote-User printed identification code is verified.
3. It was printed by an authorized registered Remote User of the Program Manager's server system and of the Issuing Station's database onto a coupon shell contained on a sheet of traceable, printable medium, issued to the Remote User.
4. In one embodiment, it is presented for redemption under the terms required by the Issuing Station, by the Redemption Station, and by the Program Manager.

The systems of verifying negotiable discount coupons may necessitate that either a real-time, live connection is made between a particular Redemption Station's computer system and the Program Manager's server system or that the Redemption Station, on a periodic and frequent basis, synchronizes the Redemption Station's computer system with the Program Manager's server system to continually update the information related to Remote User issued security codes and unique identification codes printed by Remote Users seeking discounts on associated products and/or services.

The Redemption Station's computer system (POS) may be programmed to recognize the format of the unique identification codes and may also be programmed to interpret the codes to recognize the products or services and the discounts associated with them. The Redemption Station's computer system (POS) may also be programmed to recognize the pre-printed or embedded security codes found on the traceable, printable medium. Unique identification codes may contain product or service information and related discount information that is the same for all codes associated with a certain product or service and its related discount. This will allow the POS system to recognize how to interpret the discount and the product or service to which it is tied, given that a particular Remote-User unique identification code has not yet been uploaded into the POS system, assuming the system is not on real-time synchronization.

Alternatively, an additional barcode containing the UPC code and coupon discount code may be printed in a position separate from, or as an alternative to, the unique identification code for the purpose of identifying the product and related discount being presented for redemption. As one option, once an apparent negotiable discount coupon is presented for redemption at a Redemption Station for the purpose of gaining a specified discount on a particular product or service, the cashier may scan in the security code found on the back of the coupon and the unique identification code printed by the Remote User and found on the front of the coupon. This system provides a way to insure that the unique identification code printed by the Remote User is linked with the security code assigned to that Remote User, given that the Remote-User's printed unique identification code is either uploaded into the Redemption Station's database, or can be accessed in a real-time connection between the Redemption Station's computer system (POS) and the Program Manager's server system.

In one embodiment, if the unique identification code is properly linked with the Remote-User assigned security code as required by the Program Manager, and the coupon is determined to be a negotiable coupon, the coupon may be accepted and the discount given to the Remote User for the purchase of specified products or services. If the required correlation between the security code and the unique identification code is not met, or if the coupon is otherwise found to not be a negotiable coupon, the cashier may be prompted to reject the coupon and the Remote User account assigned to the security code may be flagged for investigation.

In circumstances where the unique identification code has not yet been uploaded into the Redemption Station's database and where a real-time connection is not available, the Redemption Station's computer system may verify that the printed coupon shell is registered to a valid Remote User. The system may then allow for verification of the printed offer after the transaction is made and the Redemption Station's computer system has synchronized with the Program Manager's server system to receive new Remote-User print data.

As an additional protection against potential fraud in cases where a Redemption Station is not operating on a real-time basis with the Program Manager and a unique identification code that does not appear in the Redemption Station's system is presented for redemption, the Redemption Station's system may be programmed to recognize and to reject duplicate unique identification codes. The Redemption Station may also program its system to flag and reject unusual activity related to a specific security code being presented at different times of the day or at different locations operated by the same Redemption Station.

As an alternative method, the Remote User may print a list of discount offers for which unique identification code(s) are assigned, onto a single coupon shell for presentation at a participating Redemption Station. The cashier, by inputting or scanning the pre-printed security code, will be able to apply all discounts tied to the security code that have been verified as authorized discounts, to the purchase of their related products or services. The computer system located at the Redemption Station may be synchronized with the Program Manager's server system so that the authorized discounts may be verified.

The recording of the printing and of the redemption of discounts by Issuing Stations and Redemption Stations provides an effective medium for monitoring the purchasing behavior of a particular individual and the effectiveness of advertising campaigns. Since the identity of the Remote User is verifiable by the Issuing Stations due to the accurate method of identifying the Remote User at the time the printable medium is issued, profile information, such as age, gender, and place of residence, is precise and extremely valuable in any profile marketing campaign.

One scenario may include a method for allowing Remote Users to search discounts related to products and services being offered by the Issuing Stations participating in the system provided by the Program Manager. The search may be based on specifications input by the Remote User. Search parameters may include, but are not limited to, data requests for a specific product, specific brand, range of discount amounts, geographical radius of participating Redemption Stations, participation by a specific Redemption Station, specific merchant or manufacturer, offerings provided by a specific Issuing Station, and/or expiration dates of discount offers. In one option, Issuing Stations wishing to participate in the search system may download information related to the printing of specified discount offers to the Program Manager's computer server system, along with offer key codes identifying each individual offer or promotion.

The Program Manager's server system may place the said discount offer data and offer key code data into a database file contained in the Issuing Station's record. The Program Manager's server system may search the Issuing Station's records for discounts offers that meet the criterion requested by the Remote User. The Program Manager's server system may then return a result set for the discount offers provided by the Issuing Stations, based on the search parameters requested by the Remote User, and may then send the data to the Remote-User's client system so that the pertinent discount information can be graphically viewed by the Remote User. The Remote User may then choose the desired discount offers for printing on the provided traceable, printable medium.

In order to choose an offer provided by an Issuing Station for print, the Remote User may be required to be registered with the Issuing Station's database. If the Remote User is not registered with the Issuing Station's database, the Remote User may be prompted to register with the Issuing Station, choose new offers, or continue printing offers from Issuing Stations for which the or she is registered. In one option, the Issuing Stations may provide the Program Manager with a record of registered users of the Issuing Station's computer server system who have been identified as registered users of the Program Manager's server system, by linking the registration verification information with the Remote User's identification code provided by the Program Manager.

In one scenario, requests for the printing of the discount offers and related data received through the search system may be made directly to the Program Manager's server system, which may, on behalf of the Issuing Stations, send the discount offer data, graphics data, unique identification code, and any other print data to the Remote User's client system using an encrypted format for the printing of the discount offer and related data, as directed by the executable program or print plug-in residing on the Remote User's computer client system, onto the traceable, printable medium provided by the Program Manager to the Remote User.

Once a Remote User performs a search and chooses a discount offer presented graphically from the Program Manager's server system for print, the Program Manager's server system may also send a record of the print request, including the offer key code identifying the offer printed, to the Issuing Station's computer server system. This offer key code is a discount offer or promotion identifier possibly provided by the Issuing Station to the Program Manager, which identifier is unique to a specified discount offer or promotion.

As an alternative method, the search system may query the discount offer databases found on the Issuing Stations' computer server systems to search for discount offers and promotions meeting the parameters specified by the Remote Users. Once a result set of discount offers and/or promotions-related data has been returned to the Program Manager's computer server system, the data may be presented in graphic format to the Remote User's client system for viewing by the Remote User. In order to print the displayed offers, the Remote User may be required to log in to the desired Issuing Station's computer server system to continue with the printing procedure by requesting the print directly from the Issuing Station's computer server system.

The method may also allow for the Program Manager, with the permission of the Remote Users, to provide information to the Issuing Stations, Originator Stations, and Redemption Stations relating to the buying habits of the Remote Users. In addition, one implementation may allow for the Program Manager to solicit personal information from Remote Users to provide profile-marketing opportunities to merchants and manufacturers. For example, notifications may be sent to Remote Users by the Issuing Stations for discount opportunities relating to the buying habits, income level, and other personal attributes of individual Remote Users.

For example, a database tailored for use by the Issuing Stations and offered by the Program Manager may identify each Remote User by area, product choices, and/or coupon redemption location, and may show the number of discount offers redeemed as a percentage of those printed by the Remote User from all Issuing Stations. Additionally, the database may tracks information, such as product-use frequency and additional products chosen by the Remote Users from transactions completed at participating Redemption Stations, so that the merchants and manufacturers can gauge the effectiveness of their discount advertising campaigns.

The method may also allow for the establishment of a Remote-User interactive grocery list system, which provides an opportunity for the Remote User to input a grocery list into data fields provided by the Program Manager's server system for the purpose of initiating a search for discount offers related to the items presented on the list. Once the Remote User inputs the information from the list into the data fields, the Program Manager's server system may search its database for product discounts being provided by the participating Issuing Stations for the purpose of matching listed products with available discounts.

The Remote User may then choose any of the offers for print. In one embodiment, requests for the printing of the discount offers and related data received through the said Remote-User interactive grocery list system may be made directly to the Program Manager's server system which may, on behalf of the Issuing Stations, send the discount offer data, graphics data, unique identification code, and any other print data to the Remote User's client system using an encrypted format for the printing of the discount offer and related data, as directed by the executable program or print plug-in residing on the Remote User client system, onto the traceable, printable medium provided by the Program Manager to the Remote User.

Once a Remote User utilizing the interactive grocery list system chooses a discount offer for print, presented graphically from the Program Manager's server system, the Program Manager's server system may also send a record of the print request, including the offer key code identifying the offer printed, to the Issuing Station's computer server system. As one alternative, the said Remote-User interactive grocery list system may query the discount offer databases found on the Issuing Stations' computer server systems to search for discount offers and promotions meeting the parameters specified by the Remote Users. Once a result set of discount offers and/or promotions-related data has been returned to the Program Manager's computer server system, the data may be presented in graphic format to the Remote User's client system for viewing by the Remote User. In order to print the displayed offers, the Remote User may be required to log in to the desired Issuing Station's computer server system to continue with the printing procedure, by requesting the print directly from the Issuing Station's computer server system.

The overview of the system described includes multiple levels of security, each level providing additional protections against potential fraud and improving the flow of information for marketing purposes. For example, one of the benefits of the Remote-User printed unique identification code provided and managed by the Program Manager is that it allows specific discount offers and/or promotions chosen by the Remote User to be linked with the Remote User's assigned security code. This insures that each specific discount offer and/or promotion printed is uniquely defined, that the correct discount is known, and that the Remote User printed ID code can be verified as to its authenticity through a match with the coupon's pre-printed security code.

The security provided by the system may be seen in multiple levels. One level of security is the distribution of traceable, printable medium to positively identified individuals, with each traceable, printable medium containing security codes identifying the Remote User to whom it was assigned. This system allows for the distribution of printable stock for creating negotiable discount coupons to be tightly monitored and controlled, thereby decreasing the opportunity for duplications of the traceable, printable medium. It also allows for tracing the printable medium to the Remote User for identification and fraud prevention purposes.

For another level of security, each sheet of traceable, printable medium provided by the Program Manager to Remote Users may include at least one coupon shell containing identifying marks, in addition to a security code, for the purpose of further decreasing the opportunities for fraudulent duplications of the printable medium. In order to further increase security, each Remote User receiving traceable, printable medium may be required to register with the Program Manager's computer server system to receive authorization to print discount offers and/or promotions onto the traceable, printable medium, so that the system may verify that the Remote User registering with the system is the same Remote User to whom traceable, printable medium was issued.

Adding another level of security, an executable program or other similar program may be programmed onto the Issuing Station's computer server system, and an executable program or print plug-in may be installed on the Remote Users' client systems so that the printing of discount offers may be managed by the Program Manager, to decrease the likelihood of data capturing by Remote Users, which data may be used for fraudulent purposes, and so that the Program Manager may monitor the activity of the Remote Users to identify any attempts at fraud.

For another level of security, a unique identification code may be assigned by the Program Manager to each set of discount offer related data and graphics data being printed by a Remote User, so that each set of data is uniquely identifiable and verifiable against the security code, which decreases the likelihood of code breaking by changing the code associated with specified products and/or services for each printing, and allows the system to verify that a specific printed offer or promotion is not used more than once.

Additionally, linking the Remote User printed unique identification code with the Remote User assigned security code insures that the Remote User is working within the guidelines set by the Program Manager and that the coupon may be accurately verified by the Program Manager on behalf of a Redemption Center at the time of redemption. Real-time authentication or frequent synching of databases between Redemption Station(s) and the Program Manager also increases the level of security by providing up-to-date data on each coupon being presented for redemption.

For an additional option to further enhance security, a membership card identifying the Program Manager and containing a security code, whether embedded, or printed, and matching the security code found on the traceable, printable medium may be issued to each Remote User. The membership card may also contain personal information related to the Remote User, including a photo identification of the Remote User. The membership card may be required for presentation by the Remote User at the time of redemption of the coupon, if the Redemption Station deems additional verification necessary in one embodiment.

Reference is now made to the figures in which, for the purpose of clarity, the first digit of a reference numeral indicates the figure number in which the corresponding element is first used. While the various aspects of the embodiments disclosed are presented in drawings, the drawings are not necessarily drawn to scale.

In the following description, numerous specific details of programming, software modules, user selections, network transactions, database queries, database structures, etc., are provided for a thorough understanding of various embodiments of the systems and methods disclosed herein. However, those skilled in the art will recognize that the systems and methods disclosed can be practiced without one or more of the specific details, or with other methods, components, materials, etc.

In some cases, well-known structures, materials, or operations are not shown or described in detail. Furthermore, the described features, structures, or characteristics may be combined in any suitable manner in one or more embodiments. It will also be readily understood that the components of the embodiments as generally described and illustrated in the figures herein could be arranged and designed in a wide variety of different configurations.

The order of the steps or actions of the methods described in connection with the embodiments disclosed may be changed as would be apparent to those skilled in the art. Thus, any order in the figures or detailed description is for illustrative purposes only and is not meant to imply a required order.

Several aspects of the embodiments described will be illustrated as software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction, or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

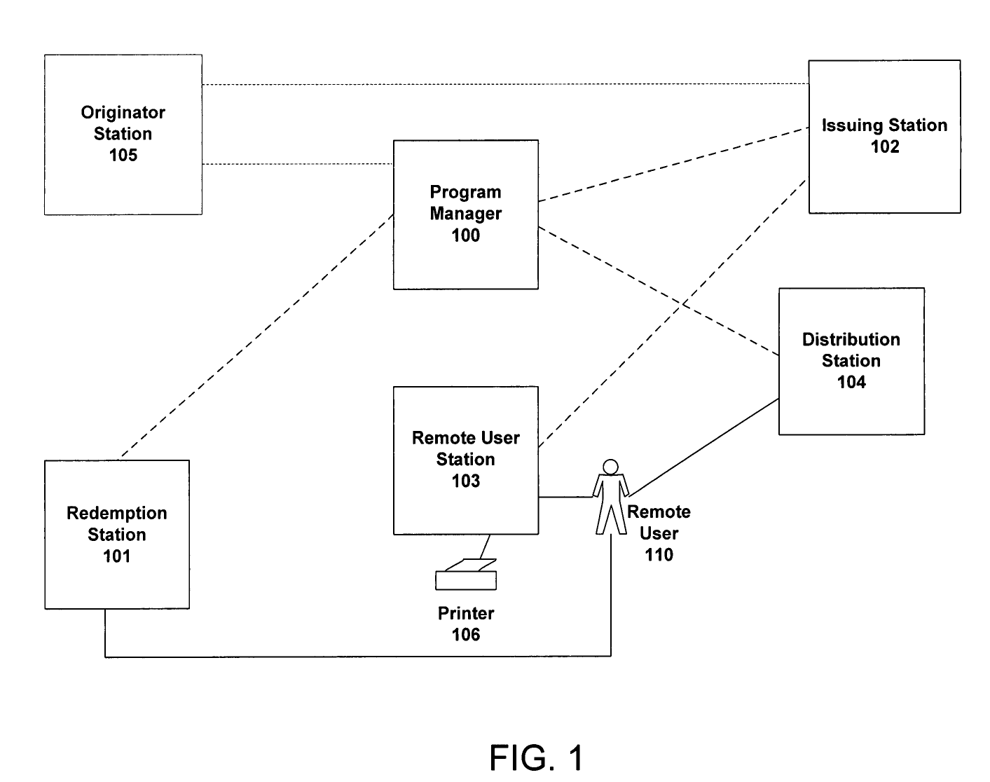

Referring now to FIG. 1, one embodiment may include the establishment of a data exchange structure in which a Program Manager becomes the central component in monitoring, verifying, and authenticating data related to specific issues of traceable, printable medium to Remote Users for the printing of discounts thereon, and for clearing coupons presented for redemption. The flow of data is shown over a wide-area network (WAN) through which six separate computer-related systems, controlled by multiple entities, communicate with one or more of the separate computer-related systems at different intervals, for the purpose of providing electronic-based discounts to Remote Users so that traceable negotiable discount coupons can be created and accurately monitored through redemption. After redemption, the coupons may be cleared electronically by the Program Manager.

Six entities, each managing a computer-related system, and a physical representation of a Remote User are shown for the purpose of identifying the components comprising the data exchange system. The Program Manager 100 provides a system for creating secure negotiable coupons, utilizing a distributed processing network and a system for verifying and authenticating negotiable discount coupons presented for redemption at a participating Redemption Station 101. The Program Manager 100 also offers a service to a Redemption Station 101 and an Originator Station 105 for electronically clearing coupons, which have been presented for redemption.

The Originator Station 105 is a manufacturer or other provider of products and services desiring to sell the products or services and is willing to authorize an Issuing Station 102 to offer discounts on specified products or services to be redeemed at a Redemption Station 101.

The Issuing Station 102 is a business entity or other organization managing at least one database of discount offers and related data, which discount offers and related data may be provided to Remote Users who desire to use the offers on specified products and/or services.

The Remote User Station 103 represents a consumer utilizing a personal computer system who wishes to take advantage of discount offers and/or promotions made available by the Issuing Station 102 on products and/or services, enabling a consumer to print at home the discounts offers and/or promotions on a printer 106 accessible to the personal computer at the Remote User Station 103.

The Redemption Station 101 is a retail outlet or other merchant which sells products and/or services offered by an Originator Station 105, for which discount offers and/or promotions have been provided to a Remote User at a Remote User Station 103 by the Issuing Station 102, for the purpose of printing on the traceable, printable medium at a printer 106 and presenting for redemption, negotiable discount coupons at the Redemption Station 101.

The Distribution Station 104 is a bank, retail outlet, or other similarly situated business, which collects verifiable personal data from and provides a physical issue of traceable, printable medium to a specific Remote User 110 for the purpose of printing discounts thereon. For descriptive purposes, FIG. 1 presupposes the Issuing Station 102 utilizing a computer server system, the Program Manager 100 utilizing a computer server system, the Remote User Station 103 utilizing a personal computer system, the Originator Station 105 utilizing a computer server system, the Distribution Station 104 utilizing a computer server system, and the Redemption Station 101 utilizing a point-of-sale system (POS). Communication among any of the systems is shown to take place over a wide-area network (WAN).

These systems are explained for descriptive purposes and are not the only system configurations available to the entities herein described. The Remote User Station, for example, may choose to use a wireless device, other Internet appliance, or a personal computer. Similar types of equipment choices, including servers and multiple configurations of computer systems, may be used by Distribution Stations, Originator Stations, Issuing Stations, and/or Redemptions Stations.

FIG. 1 shows six separate entities involved in electronic communications, through a method, which allows for multiple processes to be controlled by single entities. For example, a Distribution Station may be a retailer, who may also be a Redemption Station. A Distribution Station may be the Program Manager, who gathers verifiable data electronically and sends traceable, printable medium to Remote Users, via U.S. mail or similar method.

The Program Manager may manage database(s) of discount offers and promotions for participating in the operational processes of an Issuing Station. Similarly, other combinations of controlling processes are also possible in various embodiments. The method allows for and encourages multiple participants, other than the Program Manager, including multiple Distribution Stations, multiple Originator Stations, multiple Issuing Stations, multiple Redemption Stations, and multiple Remote User Stations. Multiple processes controlled by single entities will likely be using local-area networks (LAN), as opposed to the wide-area network (WAN) shown in FIG. 1, to communicate among computer systems, or may house all applications and processes on one single computer or server system.

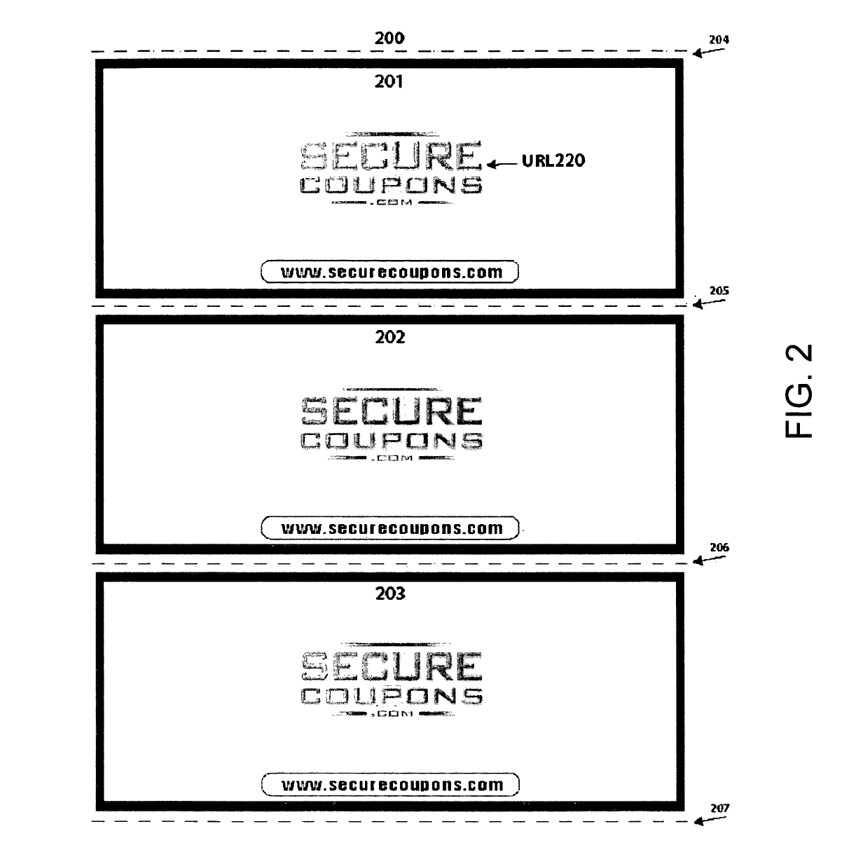

In one implementation, each Remote User is assigned a set of traceable paper, or other traceable, printable medium, which has been pre-printed or pre-encoded with a security code, in order to print discount offers and/or promotions through the system described herein. Referring now to FIG. 2, multiple sheets of traceable paper (an example of which is the sample 200) are delivered to each Remote User by the Program Manager (www.securecoupons.com, in this particular example) through, for example, a Distribution Station such as a grocery store. Each sheet of traceable paper 200 includes multiple, preprinted coupon shells, in this case, three coupon shells 201, 202, and 203. The traceable paper itself may incorporate watermarks, colored fibers, polymer security thread, or coupon formatting (also referred to as coupon shells), which may be printed, at least in part, with color-shifting ink and which may incorporate concentric fine lines, micro-printing, and/or other identifiable features which are not easily duplicated.

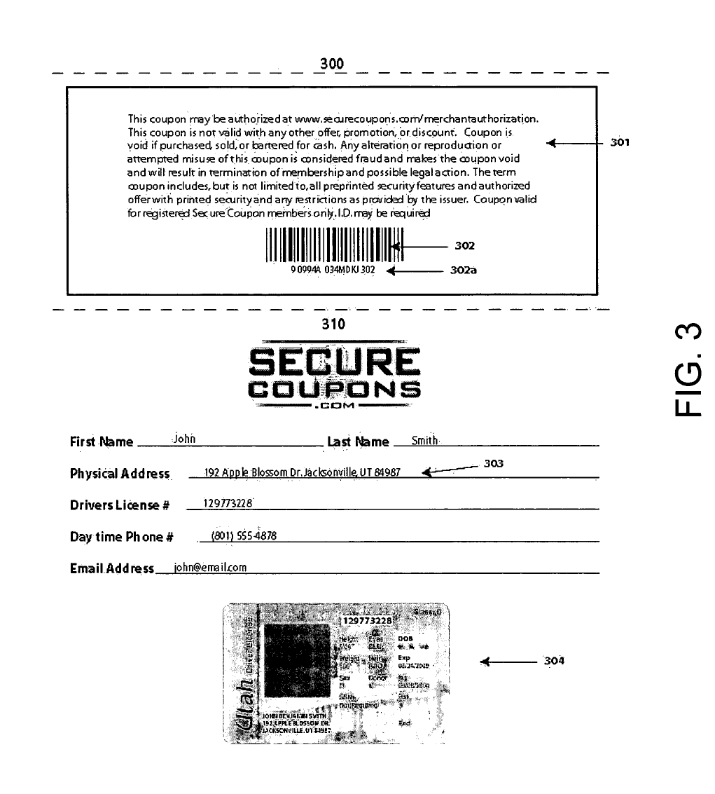

Each of the identified security features is found on currency now being printed by the United States government. Each of these features is discussed in a pamphlet entitled U.S. Currency—New Designs, published by the Federal Reserve Bank of Minneapolis, which is incorporated herein by reference. The traceable paper also includes at least one security code, which may be a barcode or other embedded code that is traceable to and which identifies, via a linking process, the receiving Remote User and may include other identifying features, such as holographic stamps much like those placed on boxes of distributed software, two-dimensional codes, and/or serial numbers. In one embodiment, the security code is shown in FIG. 3 as being printed on the back of a coupon shell in order to avoid any contact with Remote User printed data on the front of the coupon shell.

Still referring to FIG. 2, each of the three coupon shells 201, 202, and 203 includes tear perforations 204, 205, 206, and 207 along its outer perimeter. Not only do the perforations facilitate the separation of multiple coupons contained on a single sheet, the perforations may be designed to enhance security. For example, laser-cut perforations, using a special pattern that is recognizable to the naked eye, yet not easily duplicated, may be used. Again referring to FIG. 2, it will be noted that the coupon shell 201 bears a watermark of the Uniform Resource Locator 220 of the Program Manager company (in this case, www.securecoupons.com), as do coupon shells 202 and 203.

FIG. 3 shows a sample of the back of a coupon shell 300, including an example of rules, instructions, and disclaimers 301 associated with the proper usage of the coupon shells, a pre-printed security code in the form of a barcode 302, and a matching serial number 302a. FIG. 3 also illustrates an example of the information that may be requested of a Remote User to receive an issue of traceable, printable medium 310. A Remote User may be required to provide personal information 303 and proof of identification 304 to the Program Manager, or to an agent of the Program Manager, or Distribution Station (such as a grocery store or financial institution), in order to receive an issue of traceable paper, or other traceable, printable medium. Personal information 303 and proof of identification information 304, as well as the assigned security code 302 and 302a, are uploaded by the Distribution Station into the Program Manager's server system. The Program Manager's server system maintains and links the personal information with the security code 302 and 302a assigned to the Remote User.

Any discount or promotional offers with corresponding offer data, graphics data and security data, whether authorized or unauthorized, printed on the assigned coupon shells and presented for redemption, will be traceable to the Remote User to whom the traceable paper or other traceable, printable medium was issued, creating a security neither printed nor controlled by the Remote User. The Remote User's failure to comply with the rules and instructions 301 appearing on the coupon shell may result in the coupon being rejected by a Redemption Station and an investigation of the Remote User account by the Program Manager.

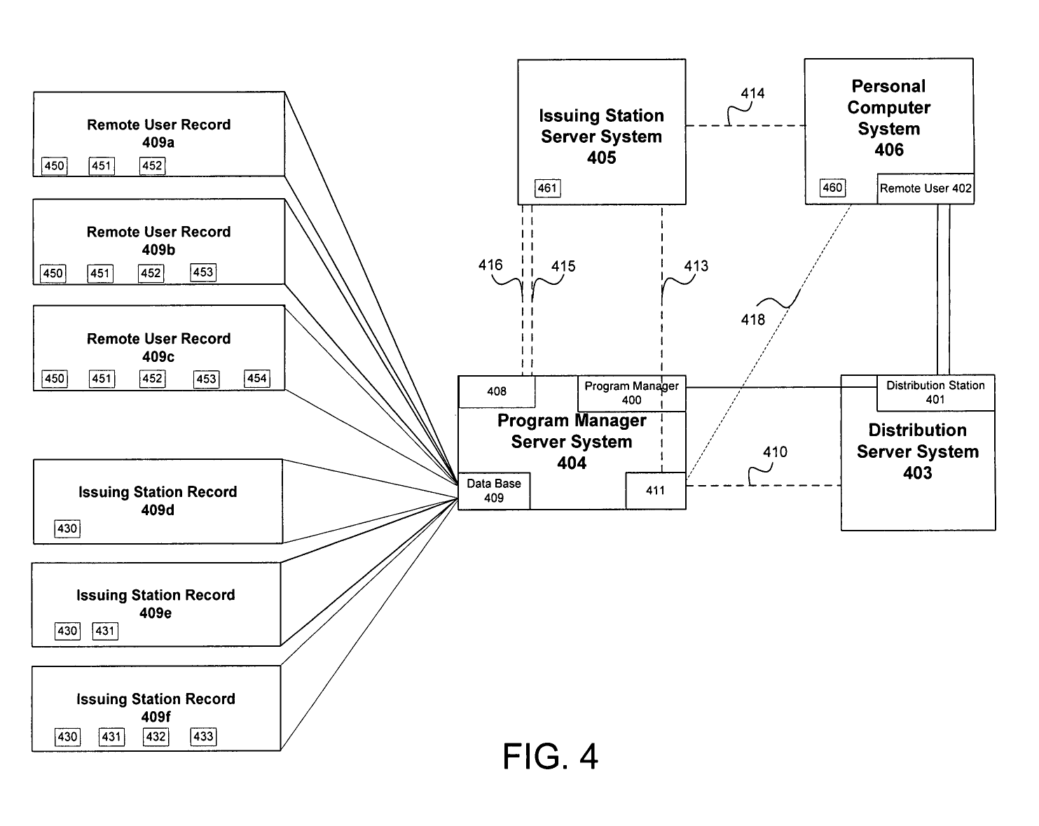

Referring to FIG. 4, in one embodiment, a Program Manager 400 is responsible to insure that a physical delivery of traceable, printable medium is delivered to a Distribution Station 401 (such as a grocery store) for the purpose of assigning the printable medium to Remote Users. Alternatively, a Program Manager may assign the traceable, printable medium to Remote Users directly. The Remote User 402 may be required to physically provide personal information, such as name, physical address, e-mail address, and phone number, as well as identification information, such as a driver's license, to the Distribution Station 401. An example of this information is shown in FIG. 3. Still referring to FIG. 4, the Distribution Station 401 may then assign and physically deliver a package of traceable, printable medium containing multiple sheets and multiple coupon shells, each containing a single security code, to the Remote User 402. These physical interactions that occur with the distribution of the traceable, printable medium, including the verification of identification, are the catalysts that create the high level of security in which all other processes are based.

In one embodiment, once the package of traceable, printable medium is distributed to the Remote User, the Distribution Station 401 utilizing a server system 403 connects electronically 410 with a web interface 411 located on the Program Manager's server system 404 and records and uploads the personal information and the Remote User identification information, in this case a driver's license, provided by the Remote User 402 with the assigned security code, to the Program Manager's server system 404, which in turn places the record in a database 409. The database record containing the personal information 450, the identification information 451, and the security code 452 is shown in the Remote User Record 409a. The program manager now has the personal information, along with a positive identification of the Remote User to whom a package of traceable, printable medium containing the assigned and recorded security code was issued. Any attempts at fraud utilizing the assigned, printable medium can now be traced to the Remote User to whom the printable medium was assigned. In addition, accurate information related to the Remote User can be verified and utilized for marketing purposes.

In one implementation, the Remote User may be directed to register with the Program Manager's database to become eligible to print discounts being offered by Issuing Stations participating in the system managed by the Program Manager. In this case, referring again to FIG. 4, the Remote User 402, utilizing a personal computer system 406, accesses the Program Manager's server system 404 by an electronic connection 418 and through the web interface 411 to register the issued package of printable medium.

The Remote User 402, utilizing a personal computer system 406, may be prompted to enter and submit the first and last name provided to the Distribution Station 401 at the time of issue of the package of printable medium, as well as the security code pre-printed on the printable medium issued by the Distribution Station 401 to the Remote User 402. Once the first and last name of the Remote User 402 and the security code found on the printable medium is submitted to the Program Manager's server system 404, the Program Manager's server processing system 408 queries the database containing the Remote User Record 409a, to verify that the first and last name and the security code submitted by the Remote User matches the record contained in the database 409a and submitted electronically 410 by the Distribution Station Server System 403.

Optionally, the Remote User may also be prompted to input a verification code found inside the distributed package of traceable, printable medium in order to complete the verification and registration process. Once the said match is made and the verification is completed, the Remote User may set up a user account ID and password. The Remote User record 409a may then be updated 409b to include information containing the Remote User account ID and password, which information is referred to herein as “Registered Member Identification” 453.

During the registration process, the Remote User 402 may be prompted by the Program Manager server system 404 web interface 411 to download an executable program 460 to reside on the Remote User personal computer system 406, to manage the handling and printing of discount offer data and other related data and the printing of unique identification codes. In one embodiment, the Remote User 402, utilizing a personal computer system 406, through the electronic connection 418, downloads the executable program 460 from the Program Manager's server system 404.

Alternatively, the said downloadable program may be a print plug-in. Once the download is complete, the Remote User may be prompted to perform a test to insure that the executable program is functioning properly and that the Remote User is able to print certain data designated by the Program Manager. After the said test has been successfully completed, the Program Manager's server system may then update the Remote User Record 409c to include a tag verifying that the Remote User has successfully installed the executable program 460 onto the personal computer system 406, the said tag referred to herein as “Executable Program Verification 454.” As another alternative, the executable program may be provided in a physical medium, such as a CD, to the Remote User with the traceable, printable medium. In this scenario, the Program Manager's server processing system 408 may verify that the executable program is operating as designed.

Various Issuing Stations wishing to utilize the system offered by the Program Manager may also go through an electronic registration. Still referring to FIG. 4, an Issuing Station utilizing a server system 405 may access the Program Manager's server system electronically 413, through a web interface 411. The Issuing Station may then be prompted to input company identification information, which may include, but is not limited to, company name, address, contact information, phone numbers, and business license information. The Issuing Station also may be required to pay a fee for the opportunity to utilize the system offered by the Program Manager. The company identification information 430 may then be recorded and stored in a database 409d on the Program Manager's server system.

In one implementation, the Issuing Station may be prompted to download from the Program Manager's server processing system 408, an executable program to facilitate electronic communication between the Issuing Station server system 405 and the Program Manager server system 404, and between the Issuing Station server system 405 and the Remote User personal computer system 406, to manage the printing of discount offer data, other related data, and the unique identification code, and also to accurately record specific data onto the Program Manager's server system 404 for all related discount offer print requests by Remote Users.

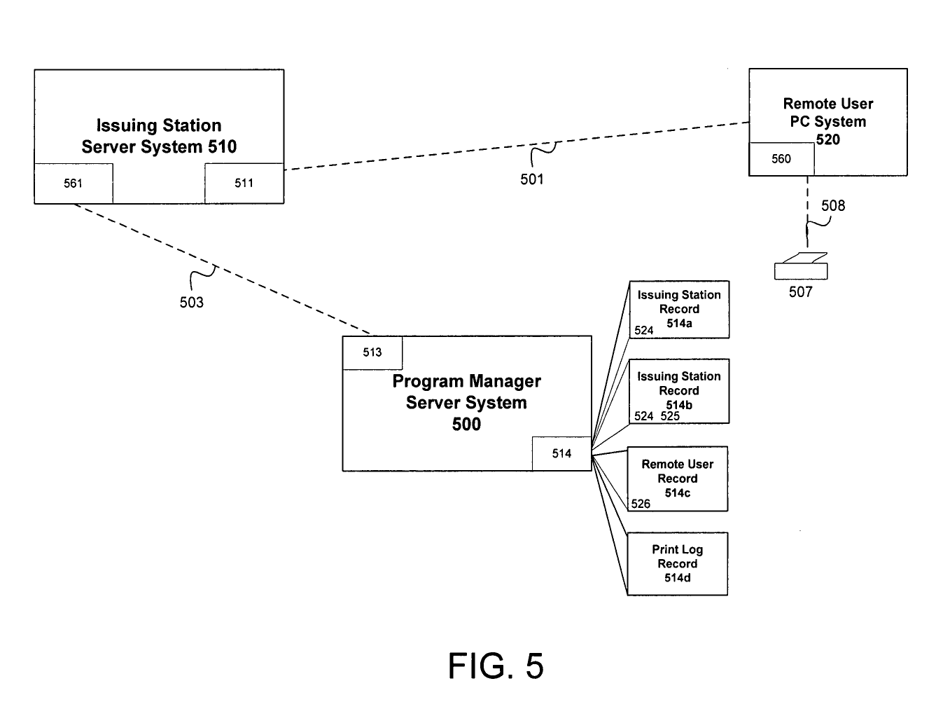

The functionality of the executable program that is downloaded onto the Issuing Station's server system, as it relates to the printing of discount offers by Remote Users, is shown in FIG. 5. This process will be addressed in greater detail in subsequent explanations. As an alternative to the executable program provided by the Program Manager, the Issuing Station may create an internal program that will perform the functions established by the Program Manager.

Once the executable program 461 is downloaded by the Issuing Station, stored onto the Issuing Station's server system 405, and determined to be functioning as designed, the Program Manager server system 404 may update the Issuing Station Record 409e found in the database 409, to reflect that the executable program 461 has been properly installed and is working. The update of the Issuing Station's record 409e is reflected by an electronic tag 431 placed on the record in the Program Manager's database. Other programming and customization between the Program Manager's server system 404 and the Issuing Station's server system 405 may be required to insure accurate record keeping and proper formatting for coupon printing. The executable program offered by the Program Manager to Issuing Station(s) is to facilitate programming by the Issuing Station(s) to conform to the specifications of the Program Manager. The method, as mentioned, allows for Issuing Station(s) to perform the programming necessary to conform to the Program Manager's specifications internally, if desired.

Once the Issuing Station has completed the registration process with the Program Manager's server system 404, the Program Manager's server processing system 408 may then electronically send 415 a pre-formatted template utilizing, for example, XML programming technology for the purpose of assisting the Issuing Station to record, in a specific format, discount offer data and related data, which data may include, but is not limited to, the discount being offered and the uniform product code of the product being discounted. The Issuing Station's server system, utilizing the XML template provided by the Program Manager, may send an electronic copy of the Issuing Station's provided discount offer record or database, including the related offer key codes to the Program Manager's server processing system 408. In turn, the Program Manager's server processing system 408 places the copy of the discount offer record, or database 432 and related offer key codes 433, into its database 409 within the Issuing Station's record 409f.

An offer key code may be defined as a discount offer or promotion identifier, which identifier is unique to a specified discount offer or promotion. The Issuing Stations may generate the unique offer key codes corresponding to discount offers and promotions found on their internal databases. This permits all offers being issued by an Issuing Station to be associated with a specific offer key code and allows the Program Manager to extract offer data provided by the Issuing Station, for internal reference purposes, from a discount offer record or database residing on the Program Manager's server system 404. Information found in the discount offer record 432 may include, but is not limited to, the discount offers, expiration dates, uniform product codes (UPC), uniform product coupon codes (UPCC), and may be found for specific discount offers through the use of offer key codes 433.

Still referring to FIG. 4, once the Remote User has received an issue of traceable, printable medium, the Remote User may then register with one or more Issuing Stations for the purpose of printing discount offers and/or promotions being provided by the Issuing Stations to its registered members. In one embodiment, the Remote User 402, utilizing a personal computer system 406, electronically connects 414 with the Issuing Station's server system 405 to register.

As part of the registration, the Remote User 402 may be directed to input the user account ID and password created during the Remote User registration process with the Program Manager's server system 404. The Issuing Station's server system 405 may then send electronically 416 Remote User input data to the Program Manager's server processing system 408. If the user account ID and password are accepted by the Program Manager's server system 404, verification is sent through the electronic connection 416 to the Issuing Station's server system 405. In one implementation, with the Remote User's permission, the Program Manager may also send information identifying the Remote User as collected during the assignment of traceable, printable medium.

Though FIG. 4, for illustration purposes, shows only one Remote User, one Issuing Station, and one Distribution Agent, the system is structured to include a large pool of Remote Users and encourages the participation of multiple Issuing Stations and multiple Distribution Agents, all operating within the framework shown in FIG. 4. Additionally, only one database managed by the Program Manager is shown to house all internal database applications. However, the method allows for multiple interactive databases to be used to accomplish the processes described herein.

FIG. 5 shows the process that may be involved in a Remote User choosing and printing discount offers provided by an Issuing Station within one implementation of the system offered by the Program Manager to create negotiable discount coupons. Referring to FIG. 5, a Remote User utilizing, in this case, a personal computer system 520 and desiring to select and print discount offers via a distributed processing network, accesses electronically 501 an Issuing Station's server system 510 via a web interface 511 to view available discount offerings provided by the Issuing Station. Still utilizing the web interface 511 resident on the Issuing Station's server system 510, the Remote User may choose to print a discount offer.

The Issuing Station's server system 510, utilizing an executable program 561 or similar program with the same functionality, electronically sends 503 the data related to the print request, to the Program Manager's server processing system 513. The data sent from the Issuing Station's server system 510 to the Program Manager's server processing system 513 might include a reference to at least some unique aspect of the Remote User's membership identification, as registered with the Program Manager. In one implementation, the uniquely identifiable aspect of the Remote User's identification information may be stored by the Issuing Station and sent automatically by the Issuing Station's server system 510 to the Program Manager's server processing system 513, whenever a print request is made by a Remote User registered with both the Issuing Station and the Program Manager.

The data being electronically sent 503 from the executable program 561 residing on the Issuing Station's server system 510 to the Program Manager's server processing system 513 may also include an offer key code, which identifies the discount offer or promotion requested by the Remote User. A record of the discount offer database 524 managed by the Issuing Station's server system 510 is maintained in the Issuing Station's record 514a within the Program Manager's database 514. Identification of a particular discount offer or promotion may be achieved through the use of the offer key code assigned to it.

Once the Program Manager's server processing system 513 receives information associated with the member identification and the offer key code related to the print request made by the Remote User and the Remote User has been identified and verified, the Program Manager's server processing system 513 may then assign a unique identification code to the discount offer request and send the information electronically 503 to the executable program 561 residing on the Issuing Station's server system 510. In one implementation, the executable program 561 residing on the Issuing Station's server system 510 formats all of the data associated with the discount offer requested by the Remote User with the unique identification code and then encrypts the data, including the unique identification code, and electronically sends 501 the data to the executable program 560 residing on the Remote User's personal computer system 520.

Once the said data is received by the executable program 560, the program decrypts the data, applies the appropriate calibration specifications, and sends the data properly formatted to a printer 507 connected 508 to the Remote User personal computer system 520, for printing on the traceable, printable medium within the coupon shells provided. The said calibration specifications may then be determined by a query from the executable program 560 to the personal computer operating system to determine the available print area of the printer attached to or networked to the Remote User's personal computer system 520. The operating system returns a result set, which includes maximum x and y print coordinates, to the executable program that allows the executable program to calculate appropriate placing of text, graphics, and security data within the coupon shells.

Once the Program Manager's server processing system 513 has received and processed all of the data associated with a print request by a Remote User from the Issuing Station's server system 510 and a unique identification code has been assigned, the server processing system 513 may then update, within the database 514, the print activity file 525 found in the Issuing Station's record 514b and may update the print file 526 found in the Remote User record 514c, for the purpose of recording the print activity and related data associated with a specific printing of a discount offer or promotion, so that the print activity may be traced back to the Remote User who performed the printing and to the Issuing Station that provided the discount offer or promotion.

Additionally, within the database 514, a print log record 514d may be updated to include the new print request along with all of the related data, including the Unique Identification code, the offer key code, and the Remote User assigned security code. Recorded data related to a specific Remote User printing may be found in the print log record 514d and, in one implementation, is filed and identified by the unique identification code associated with it.

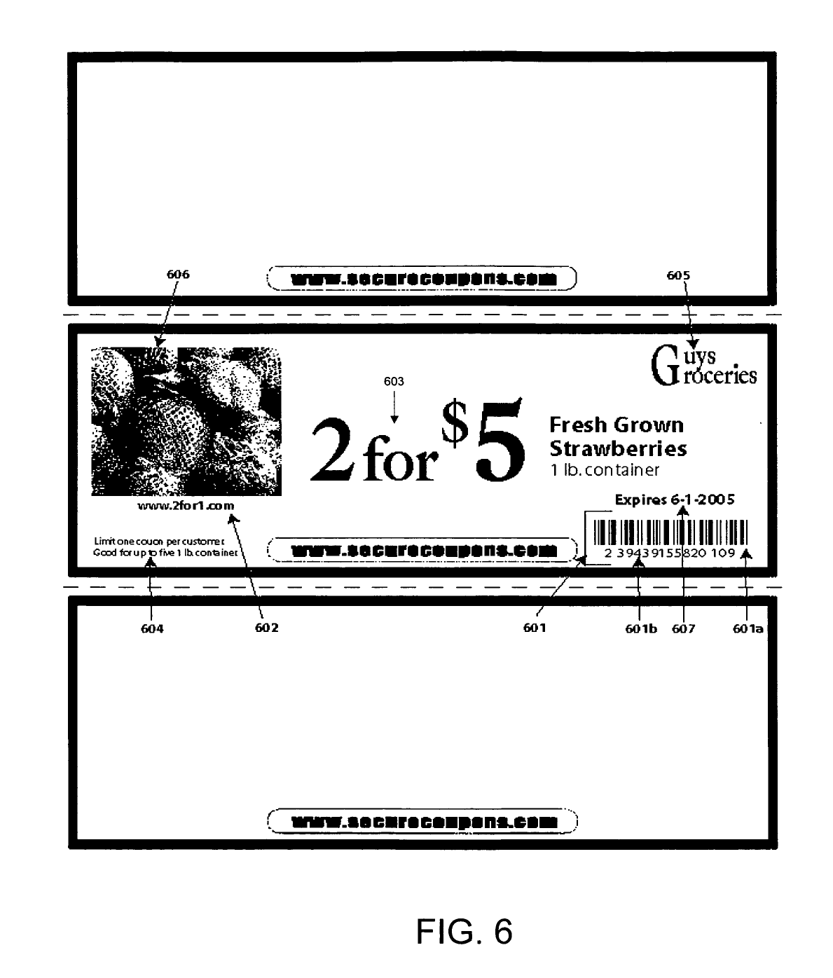

Once a Remote User has complied with guidelines set forth by the Program Manager and by the Issuing Station providing discount offers and/or promotions desired by the Remote User, and the Remote User has printed a discount offer or promotion and other data onto an assigned coupon shell, the printed, or completed coupon shell becomes a negotiable discount coupon. Referring to FIG. 6, the unique identification code 601, located at the bottom right-hand corner of the completed coupon shell, shown as a 128 format barcode 601a and as a set of numeric characters 601b, is provided by the Program Manager and includes information sufficient to identify the product or service for which a discount or promotion has been printed, as well as the amount of discount being offered. It may also include information connecting the Remote User's personal information and assigned security code to the printing of the specific discount offer or promotion.

Other information which may be tied to the unique identification code may be, but is not limited to, time and date of printing of discount offer data, Issuing Station from which the search was performed, number of prints chosen by a Remote User within a given print session (more than one offer being chosen for print at the same time), data related to other products, for which discount data was printed in the same print session and family code information related to specific products being discounted. The unique identification code changes with every Remote User printing of discount offers and/or promotions within the system managed by the Program Manager. This creates an added level of security by insuring that each set of data is uniquely identifiable and applicable to a particular security code, which increases verification accuracy and decreases the likelihood of code breaking, and allows the system to verify that a specific printed offer or promotion is not used more than once.

Still referring to FIG. 6, the name of the Issuing Station 602 (in this case, www.2for1.com) appears near the bottom left-hand corner of the coupon shell. The mock-up discount offer 603, rules and disclaimers related to the offer 604, the Originator Station name 605, graphic of product offered 606, and the expiration date of the offer 607 are also printed on the coupon shell.

In one embodiment, the Issuing Station name, discount offer and graphics data 602, 603, 604, 605, 606, and 607 are provided by the Issuing Station, and the wording of this data and the inclusion or exclusion of certain parts of this data type, the placement of this data type within the boundaries set by the Program Manager, and the provided graphics may vary and is controlled by the Issuing Station. The Program Manager, however, controls the make-up and placement of the unique identification code 601, printed by the Remote User onto the coupon shell. This will allow for uniformity as the negotiable discount coupons go through the redemption process. With the discount offer or promotion and related data, and the unique identification code properly formatted and printed within the coupon shell on the assigned traceable, printable medium, the Remote User is in possession of a negotiable discount coupon and may redeem the said coupon at any participating Redemption Station.

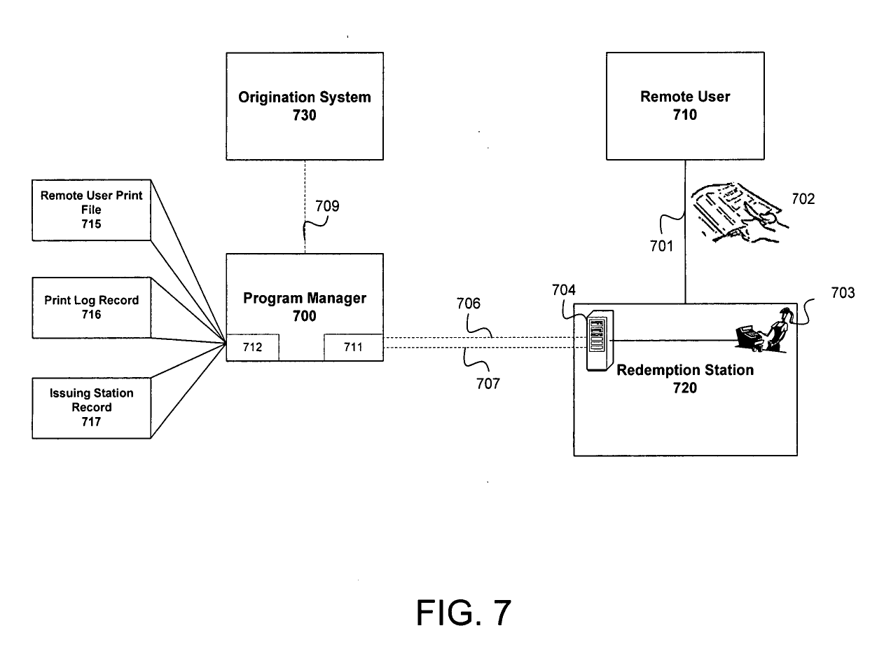

Referring to FIG. 7, in this case the Remote User 710 makes a physical presentation 701 of a negotiable discount coupon 702 to a cashier 703 working at a Redemption Station 720, which is a grocery store. In one embodiment, the cashier 703, after scanning in the products to be purchased, receives the negotiable discount coupon 702 from the Remote User 710, and utilizing a barcode reader connected to a point-of-sale (POS) computer system 704, scans in the security code identifying the Remote User to whom the coupon shell was assigned along with the unique identification code provided by the Program Manager and printed by the Remote User.

If a real-time, instantaneous connection is available between the Redemption Station and the Program Manager, the Redemption Station computer system may then electronically send 706 a request for verification of the unique identification code and the security code to the Program Manager's server processing system 711. The Program Manager's server processing system 711 queries the print log record 716 found in the server system's database 712, links the security code with the unique identification code, and sends electronically 706 a verification that the two said codes have been found and verified together. The Redemption Station's computer system receives the verification and applies the discount or promotion related to the product purchased by the Remote User.

In one embodiment for clearing redeemed coupons, the Redemption station, once the discount is given and the transaction has been completed, electronically sends 707 a transaction code to the Program Manager's server processing system 711. In the database 712, the server processing system 711 updates the Remote User print file 715, the Issuing Station's record 717, and the print log record 716 with the transaction code. In one option, with the receipt of a transaction code, the Remote User printed discount offer is considered to be properly redeemed and cleared. The Program Manager may then send an electronic communication 709 to the Originator Station 730, in this case, a consumer goods manufacturer, authorizing the discount on the related manufacturer's product to provide notification that a discount has been properly presented to and redeemed by a specified Redemption Station. The Program Manager may then facilitate any financial transactions necessary between the Originator Station and the Redemption Station as it relates to the clearing of a negotiable discount coupon.

Though FIG. 7 illustrates all transactions happening in real-time, the system recognizes that not all Redemption Stations may have real-time connections with the Program Manager. In cases where a real-time connection does not exist, the Redemption Stations may synchronize their computer systems on a frequent basis with the Program Manager's server system so that the Program Manager may provide Redemption Stations with all valid security codes associated with traceable, printable medium assigned to Remote Users.

The Program Manager may also update the Redemption Station's computer systems with all assigned unique identification codes for printed discounts not yet presented for redemption. If a coupon is presented and the security code associated with the coupon is found in the Redemption Station's computer system, but the unique identification code is not, the Redemption Station may accept the coupon and complete the verification process along with the sending of the associated transaction code on the next synchronization with the Program Manager's server system. Though this last presented scenario is less secure, the coupon can still be traced back to the Remote User to whom the traceable, printable medium was issued.

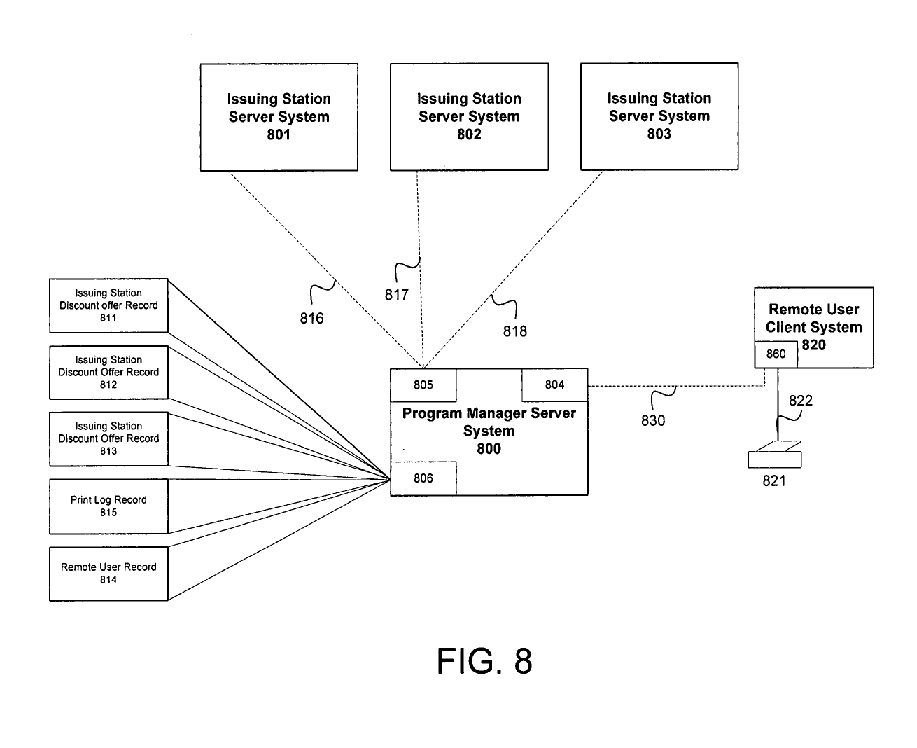

One embodiment may also provide for an interactive grocery list system, which system may allow Remote Users to search the discount offer records maintained in the Issuing Stations' records for discount offers and/or promotions on grocery items, as input into the system by the Remote User. FIG. 8 illustrates a Remote User using a client system 820 to access electronically 830 the Program Manager's server system 800 web interface 804, for the purpose of finding discount or promotion opportunities on specific grocery items. Through the web interface 804, the Remote User may access the interactive grocery list search system to input requests for discounts or promotions on desired grocery items.

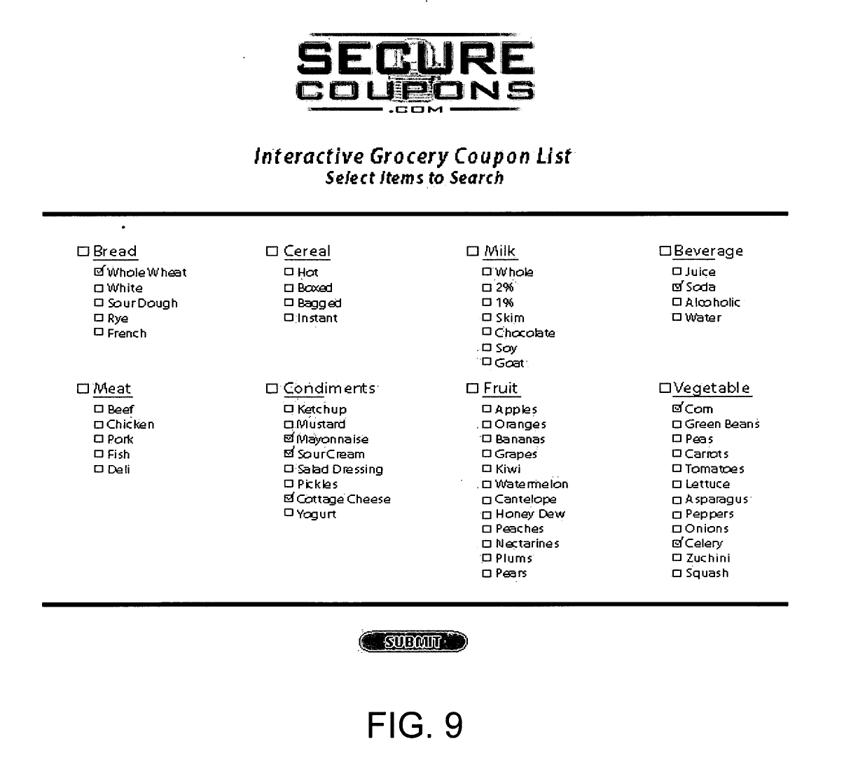

FIG. 9 shows one example of the graphical presentation of input fields for an interactive grocery list search system. Referring to FIG. 9, a sample of categories of grocery items are displayed with accompanying check boxes for Remote User choice selections. The Remote User may choose, by clicking on a particular check box, specific grocery items included on the shopping list to find related discounts or promotions and may then submit the requests for search.

Referring back to FIG. 8, the Remote User-requested search is sent to the server processing system 805, which queries the database 806, and the Issuing Stations discount offer records 811, 812, and 813 to match any related promotions or discounts to the product choices selected by the Remote User. The server processing system 805 may then graphically display all of the results through the web interface 804 to the Remote User client system 820.

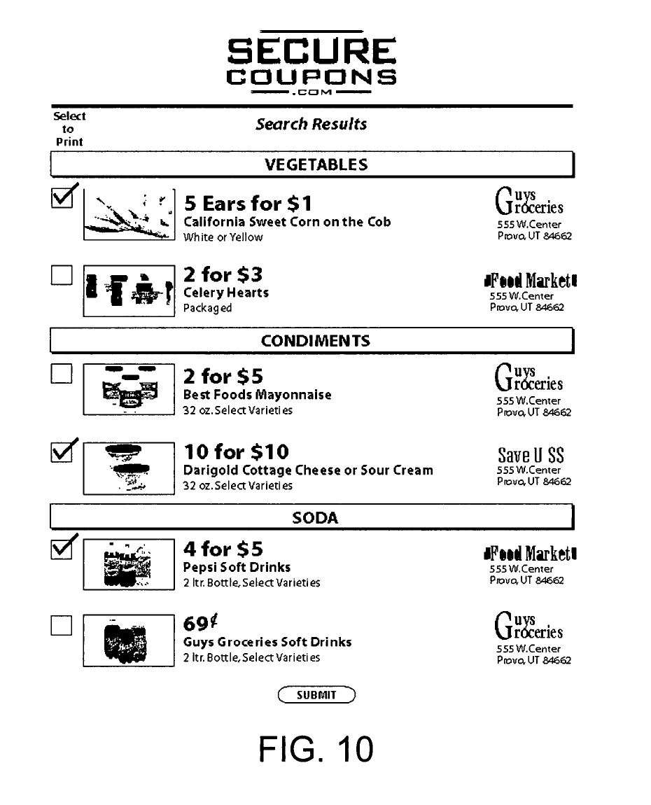

One example of displayed search results is shown in FIG. 10. Referring to FIG. 10, the Remote User may select the desired discounts for print and may then submit the request to the Program Manager's server system. Referring back to FIG. 8, in one implementation, the server processing system 805 acts upon the said Remote User request by creating unique identification codes for each discount offer requested and then sends, through the electronic connection 830, the discount offer data, the unique identification code, the graphics data, and any other data, to the executable program 860 residing on the Remote User personal computer system, using an encrypted format.

The executable program 860 may then decrypt the said data and the unique identification code, apply the appropriate calibration, and send the data to the printer 821 connected 822 to the client system 820 for printing on a coupon shell. The Program Manager server system 800 may also send a record of the printing to the Issuing Stations providing the discount offers.

In one embodiment, the Program Manager server system 800 may establish electronic connections 816, 817, and 818 with the Issuing Stations' server systems 801, 802, and 803 housing the discount offers chosen by the Remote User for printing, and send a record of the request for the printing of the specified discounts, so that the Issuing Stations are informed that an offer has been chosen for print by a specific Remote User.

In one embodiment, also included in the electronic transmissions from the Program Manager server system 800 to the Issuing Stations server systems 801, 802, and 803, is information to identify the Remote User to the Issuing Stations and the offer key codes identifying the discount offers chosen for print by the Remote User. The Program Manager server processing system 805 may record the print transaction, including the Remote Users registered membership identification, the offer key codes and the unique identification codes in the Print Log record 815, the Remote User Record 814, and the Issuing Stations records 811, 812, and 813.

While specific embodiments and applications of various methods and systems for conducting experiments over the Internet have been illustrated and described, it is to be understood that the invention claimed hereinafter is not limited to the precise configuration and components disclosed. Various modifications, changes, and variations apparent to those of skill in the art may be made in the arrangement, operation, and details of the methods and systems disclosed.

Furthermore, the methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified without departing from the scope of the invention as claimed.

The embodiments disclosed may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware.

Embodiments of the present invention may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the invention as claimed hereinafter.

What is claimed is:

1. A method for increasing security in the issuance of discount coupons to consumers, comprising:
providing a traceable, printable medium to remote users for the printing of discount offer data thereon in order to create negotiable discount coupons, each traceable, printable medium comprising at least one coupon shell including a prerecorded security code traceable to the remote user to whom it was provided;
maintaining, in at least one database, identification data related to each remote user to whom the traceable, printable medium was provided, the at least one database providing an electronic link between at least one aspect of the identification data and the prerecorded security code;
establishing an electronic connection to at least one issuing station that includes at least one searchable database of discount offers accessible via a distributed processing network;
providing electronic verifications to each issuing station that a specific remote user has met one or more requirements imposed by a program manager to print discounts onto an issue of traceable, printable medium provided by a program manager;
recording data for each discount offer chosen for print by a remote user; and
linking the recorded data to the security code found on the package of traceable, printable medium issued to the remote user choosing to print a particular discount offer.

2. The method of claim 1, wherein the traceable, printable medium is paper.

3. The method of claim 1, wherein each coupon shell includes at least one of the following features: a watermark, colored fibers, a holographic stamp, a two-dimensional code, printing with concentric fine lines, micro printing, and color-shifting ink.

4. The method of claim 1, wherein each coupon shell includes perforated tear lines, which facilitate the separation of the individual coupons.

5. The method of claim 1, wherein the prerecorded security code is a barcode.

6. The method of claim 1, wherein the prerecorded security code and the identification data of the remote user are linked in a database residing on a computer server system managed by the program manager.

7. The method of claim 1, wherein at least one issuing station is operated by the program manager.

8. The method of claim 1, further comprising:
establishing a connection to at least one redemption station where discount coupons may be redeemed; and
providing electronic verifications to each redemption station of the authenticity of completed coupon shells including discount offer information printed thereon by remote users, which completed coupon shells are submitted for redemption.

9. The method of claim 8, wherein a program manager provides a service for the electronic clearing of completed coupon shells presented for redemption.

10. The method of claim 1, wherein each remote user is identified by name, residence address, and an authenticating number of an official issuance.

11. The method of claim 10, wherein the official issuance includes at least one of a driver's license, a social security card and a credit card.

12. The method of claim 9, wherein the provided service is provided via the Internet.

13. The method of claim 1, further comprising:
establishing an electronic connection with a plurality of remote users; and
providing a print control program to remote users to manage the printing of and the placement of discount offer data and security data onto coupon shells.

14. The method of claim 13, wherein the print control program calibrates the printing of data from a remote user client system to fit within the coupon shells provided.

15. The method of claim 13, wherein the print control program is an executable program.

16. The method of claim 13, wherein the print control program interacts with the Internet browser residing on the remote user client system.

17. The method of claim 1, wherein a print control program contained on a physical medium is provided to remote users for the purpose of managing the printing of discount offer data and security data on to coupon shells.

18. The method of claim 1, wherein the recorded data is a barcode identifying the product and a discount offer for a specific item to be purchased.

19. The method of claim 1, wherein the recorded data is a unique identification code.

20. The method of claim 19, wherein the unique identification code is created by the program manager for every discount offer chosen for print by a remote user.

21. The method of claim 9, wherein the electronic clearing is accomplished by matching at least one aspect of the security code with the recorded data related to the printed discount offer.

22. The method of claim 21, wherein a transaction code is sent electronically from the redemption station to a program manager, identifying the transaction for which a discount coupon was applied through redemption.

23. The method of claim 1, further comprising:
providing a graphical interface via a distributed processing network to remote users for the purpose of creating an interactive grocery shopping list;
providing a system for searching for discount offers on products matching one or more fields input by the remote user in the grocery shopping list graphical interface;
graphically displaying a result set of discount offers matching one or more fields input by the remote user; and
providing a system to remote users for printing the displayed discount offers onto traceable, printable medium.

24. A method for increasing security in the issuance of discount coupons to consumers, the method comprising:
providing a traceable, printable medium to remote users for the printing of discount offer data thereon in order to create negotiable discount coupons, each traceable, printable medium comprising at least one coupon shell including a prerecorded security code traceable to the remote user to whom it was provided;
maintaining, in at least one database, identification data related to each remote user to whom the traceable, printable medium was provided, the at least one database providing an electronic link between at least one aspect of the identification data and the prerecorded security code;
establishing an electronic connection with a plurality of remote users;
providing for electronic registrations by remote users with a program manager;
linking the prerecorded security codes found on the traceable, printable medium with the remote user registrations;
establishing an electronic connection to at least one issuing station that includes at least one searchable database of discount offers accessible via a distributed processing network;
providing electronic verifications to each issuing station that a specific remote user has met one or more requirements imposed by the program manager to print discounts onto an issue of traceable, printable medium provided by the program manager;
recording data for each discount offer chosen for print by a remote user;
linking the recorded data to the security code found on the package of traceable, printable medium issued to the remote user choosing to print a particular discount offer;
establishing an electronic connection to at least one redemption station where discount coupons may be redeemed; and
providing electronic verifications to each redemption station of the authenticity of completed coupon shells including discount offer information printed thereon by remote users, which completed coupon shells are submitted for redemption.

25. The method of claim 24, wherein the traceable, printable medium is paper.

26. The method of claim 24, wherein each coupon shell includes at least one of the following features: a watermark, colored fibers, a holographic stamp, a two-dimensional code, printing with concentric fine lines, micro printing, and color-shifting ink.

27. The method of claim 24, wherein the coupon shell includes perforated tear lines, which facilitate the separation of the individual coupons.

28. The method of claim 24, wherein the prerecorded security code is a barcode.

29. The method of claim 24, wherein the prerecorded security code and the identification data of the remote user are linked in a database residing on a computer server system managed by a third-party program manager.

30. The method of claim 24, wherein at least one issuing station is operated by the program manager.

31. The method of claim 24, wherein a program manager provides a service for the electronic clearing of completed coupon shells presented for redemption.

32. The method of claim 24, wherein each remote user is identified by name, residence address, and an authenticating number of an official issuance.

33. The method of claim 32, wherein the official issuance includes at least one of a driver's license, a social security card, and a credit card.

34. The method of claim 24, wherein the electronic connections and verifications are provided via the Internet.

35. The method of claim 24, wherein a print control program is provided to remote users to manage the printing and placement of discount offer data and security data onto coupon shells.

36. The method of claim 35, wherein the print control program calibrates the printing of data from a remote user client system to fit within the coupon shells provided.

37. The method of claim 35, wherein the print control program is an executable program.

38. The method of claim 35, wherein the print control program interacts with the Internet browser residing on the remote user client system.

39. The method of claim 24, wherein a print control program contained on a physical medium is provided to remote users for the purpose of managing the printing of discount offer data and security data on to coupon shells.

40. The method of claim 24, wherein the recorded data is a barcode identifying the product and a discount offer for a specific item to be purchased.

41. The method of claim 24, wherein the recorded data is a unique identification code.

42. The method of claim 41, wherein the unique identification code is created by a program manager for every discount offer chosen for print by a remote user.

43. The method of claim 31, wherein the electronic clearing is accomplished by matching at least one aspect of the security code with the recorded data related to the printed discount offer.

44. The method of claim 43, wherein a transaction code is sent electronically from the redemption station to a program manager identifying the transaction for which a discount coupon was applied through redemption.

45. The method of claim 24, further comprising:
providing a graphical interface via a distributed processing network to remote users for the purpose of creating an interactive grocery shopping list;
providing a system for searching for discount offers on products matching one or more fields input by the remote user in the grocery shopping list graphical interface;
graphically displaying a result set of discount offers matching one or more fields input by the remote user; and
providing a system to remote users for printing the displayed discount offers onto traceable, printable medium.

46. A method for increasing security in the issuance of discount coupons to consumers, the method comprising:
providing a traceable, printable medium to remote users, whose identities are verified through an official issuance or record, for the printing of discount offer data thereon in order to create negotiable discount coupons, each traceable, printable medium comprising at least one coupon shell including a prerecorded security code traceable to the remote user to whom it was provided;
maintaining, in at least one database, identification data related to each remote user to whom the traceable, printable medium was provided, the at least one database providing an electronic link between at least one aspect of the identification data and the prerecorded security code;
establishing an electronic connection with a plurality of remote users;
providing for electronic registrations by remote users with a program manager;
linking the prerecorded security codes found on the traceable, printable medium with the remote user registrations;
providing a print control program to remote users to manage the printing of discount offer data and security data onto coupon shells;
establishing an electronic connection to at least one issuing station that includes at least one searchable database of discount offers accessible via a distributed processing network;
providing electronic verifications to each issuing station that a specific remote user has met one or more requirements imposed by the program manager to print discounts onto an issue of traceable, printable medium provided by the program manager;
assigning and recording a code for each discount offer chosen for print by a remote user;
linking each assigned and recorded code to the security code found on the package of traceable, printable medium issued to the remote user choosing to print a particular discount offer;
establishing an electronic connection to at least one redemption station where discount coupons may be redeemed;
providing electronic verifications to each redemption station of the authenticity of completed coupon shells including discount offer information printed thereon by remote users, which completed coupon shells are submitted for redemption; and
providing a service for the electronic clearing of completed coupon shells presented for redemption; which electronic clearing is accomplished by verifying a predetermined relationship between the security codes and the assigned and recorded codes printed by remote users.

47. The method of claim 46, wherein the traceable, printable medium is paper.

48. The method of claim 46, wherein the prerecorded security code is a barcode.

49. The method of claim 46, wherein at least one issuing station is operated by the program manager.

50. The method of claim 46, wherein the official issuance includes at least one of a driver's license, a social security card, and a credit card.

51. The method of claim 46, wherein the electronic connections and verifications are provided via the Internet.

52. The method of claim 46, wherein the recorded code assigned to each discount offer chosen for print by a remote user is a barcode identifying the product and a discount offer for a specific item to be purchased.

53. The method of claim 46, wherein the recorded code assigned to each discount offer chosen for print by a remote user is a unique identification code created by a program manager.

54. The method of claim 46, wherein a transaction code is sent electronically from the redemption station to a program manager identifying the transaction for which a discount coupon was applied through redemption.

55. A system for increasing security in the issuance of discount coupons to consumers, the system comprising:
means for providing printable medium to remote users to allow for the printing of discount offer data thereon to create negotiable discount coupons, each traceable, printable medium comprising at least one coupon shell including a prerecorded security code traceable to the remote user to whom it was provided;
means for maintaining verifiable identification data related to each remote user to whom the printable medium was provided;
means for electronically linking at least one aspect of the identification data with the prerecorded security code found on the printable medium provided to a remote user;
means for recording data related to specific discount offers chosen for print by a remote user; and
means for linking the recorded data related to specific discount offers with the prerecorded security codes found on the traceable, printable medium onto which the discount offers are printed.

56. The system of claim 55 wherein the recorded data related to specific discount offers are unique identification codes created by a program manager and assigned to each discount offer chosen for print by a remote user.

57. The system of claim 55, wherein the prerecorded security code is a barcode.

58. A system for verifying the authenticity of coupons containing discounts printed by remote users and for the electronic clearing of negotiable discount coupons containing remote user printed discounts, the system comprising:
means for providing printable medium to remote users to allow for the printing of discount offer data thereon to create negotiable discount coupons, each traceable, printable medium comprising at least one coupon shell including a prerecorded security code traceable to the remote user to whom it was provided;
means for maintaining verifiable identification data related to each remote user to whom the printable medium was provided;
means for electronically linking at least one aspect of the identification data with the prerecorded security code found on the printable medium provided to a remote user;
means for recording data related to specific discount offers chosen for print by a remote user;
means for linking the data related to specific discount offers with the prerecorded security codes found on the traceable, printable medium onto which the discount offers are printed;
means for providing electronic verifications to at least one issuing station of the validity of specific remote users to participate in the printing of discount offers onto traceable, printable medium;
means for providing electronic verifications to at least one redemption station that a particular coupon including remote-user printed discounts presented for redemption has been printed on a valid issue of traceable, printable medium, and that the prerecorded security code found on the completed coupon shell matches one predetermined aspect of the recorded data related to the discount offer chosen and printed by the remote user; and
means for clearing negotiable discount coupons including remote user printed discounts that have been presented for redemption, verified, and applied to a particular transaction.

59. The system of claim 58, wherein the recorded data related to specific discount offers are unique identification codes assigned and created by a program manager.

60. The system of claim 58, wherein the prerecorded security code is a barcode.

61. The system of claim 58, wherein a transaction code identifying a specific transaction to which a redeemed negotiable discount coupon has been applied is generated, recorded, and linked with the prerecorded security code, the verifiable identification data and the recorded data related to a specific discount offer printed by a particular remote user.

62. A system for increasing security in the issuance of discount coupons to consumers and for verifying and clearing discount coupons presented for redemption, the system comprising:
means for providing printable medium to remote users to allow for the printing of discount offer data thereon to create negotiable discount coupons, each traceable, printable medium comprising at least one coupon shell including a prerecorded security code traceable to the remote user to whom it was provided;
means for maintaining verifiable identification data related to each remote user to whom the printable medium was provided;
means for electronically linking at least one aspect of the identification data with the prerecorded security code found on the printable medium provided to a remote user;
means for providing a print control program to remote users to manage the printing and placement of data onto coupon shells;
means for assigning and recording codes to specific discount offers chosen for print by a remote user;
means for linking the codes assigned to specific discount offers with the prerecorded security codes found on the traceable, printable medium onto which the discount offers are printed;
means for providing electronic verifications to at least one issuing station of the validity of specific remote users to participate in the printing of discount offers onto traceable, printable medium;
means for providing electronic verifications to at least one redemption station that a particular coupon including remote-user printed discounts presented for redemption has been printed on a valid issue of traceable, printable medium, and that the prerecorded security code found on the completed coupon shell matches one predetermined aspect of the assigned and recorded code printed by the remote user; and
means for clearing negotiable discount coupons containing remote user printed discounts that have been presented for redemption, verified, and applied to a particular transaction.

63. The system of claim 62, wherein the codes assigned to specific discount offers are unique identification codes created and assigned by a program manager.

64. The system of claim 62, wherein the prerecorded security code is a barcode.

65. The system of claim 62, wherein a transaction code identifying a specific transaction to which a redeemed negotiable discount coupon has been applied is generated, recorded, and linked with the prerecorded security code, the verifiable identification data and the assigned and recorded code printed by a particular remote user.

66. The system of claim 62, wherein remote user printed data is automatically calibrated and placed into coupon shells by the print control program.

67. The system of claim 62, wherein the print control program is an executable program.

68. The system of claim 62, wherein the print control program interacts with the Internet browser residing on the remote user client system.

69. The system of claim of claim 62, wherein the print control program is provided to remote users on a physical medium.
